(19) United States
(12) Patent Application Publication
(10) Pub. No.: US 2005/0248150 A1
(43) Pub. Date: Nov. 10, 2005

(54) Pressurized fluid delivery output assembly

(76) Inventors: Richard J. Gilpatrick, Whitewater, WI (US); Barry Fay, Janesville, WI (US)

Correspondence Address: MICHAEL BEST & FRIEDRICH, LLP, 100 E WISCONSIN AVENUE, MILWAUKEE, WI, 53202, US

(21) Appl. No.: 10/842,588

(22) Filed: May 10, 2004

(51) Int. Cl. F16J 15/00

(52) U.S. Cl. 285/92; 239/143

(57) ABSTRACT

The present invention includes an output assembly used with a pressurized fluid delivery apparatus. The delivery apparatus has an output device fluidly connected to an output conduit and at least two support members defining a first plane and an uppermost surface spaced from the first plane. The delivery apparatus defines a second plane including the uppermost surface that is substantially parallel with the first plane. The output assembly includes an input conduit having an input in fluid communication with the delivery apparatus to receive a pressurized fluid therefrom. The input conduit also has an output in fluid communication with the output conduit. The output assembly also includes a retainer coupling the input conduit with the delivery apparatus. The retainer rigidly supports the input conduit on the delivery apparatus such that a portion of the output conduit is always disposed above the second plane during normal operation of the delivery apparatus.

### FIELD OF THE INVENTION

This invention relates generally to apparatus that provides pressurized fluids such as pressure washers and liquid sprayers.

### BACKGROUND OF THE INVENTION

Pressure washer assemblies are well known in the art to provide a highly-pressurized spray of water, or other liquid, for cleaning or other purposes. Conventional pressure washers comprise a power unit that drives a pump to provide the pressurized liquid to a rigid wand or other conduit. The wand is typically coupled to a gun assembly to act as an extension to the gun assembly. The gun assembly includes a hand grip for an operator to grasp with one hand, and the wand includes a handle to grasp with the other hand. A trigger is located near the hand grip to allow the operator to selectively operate the gun assembly. The gun assembly is typically fluidly connected with the pump by a flexible hose, which allows the power unit and the pump to remain in one place while the operator moves around and operates the gun assembly.

### SUMMARY OF THE INVENTION

The present invention provides, in one aspect, an output assembly adapted for use with a pressurized fluid delivery apparatus. The fluid delivery apparatus includes an output device, such as a nozzle or gun assembly, fluidly connected to an output conduit. The delivery apparatus also includes at least two support members defining a first plane and an uppermost surface spaced from the first plane. The delivery apparatus defines a second plane including the uppermost surface that is substantially parallel with the first plane. The output assembly includes an input conduit having an input in fluid communication with the delivery apparatus to receive a pressurized fluid therefrom. The input conduit also has an output in fluid communication with the output conduit. The output assembly also includes a retainer coupling the input conduit with the delivery apparatus. The retainer rigidly supports the input conduit on the delivery apparatus such that a portion of the output conduit is always disposed above the second plane during normal operation of the delivery apparatus.

The present invention provides, in another aspect, a pressurized fluid delivery apparatus including a frame having at least two support members defining a first plane and an uppermost surface spaced from the first plane. The frame defines a second plane including the uppermost surface that is substantially parallel with the first plane. The delivery apparatus also includes a pump supported by the frame and adapted to provide a pressurized fluid, an input conduit having an input that receives the pressurized fluid from the pump and having an output. The delivery apparatus further includes an output conduit in fluid communication with the output of the input conduit, and a retainer coupling the input conduit with the frame. The retainer rigidly supports the input conduit on the frame such that a portion of the output conduit is always disposed above the second plane during normal operation of the delivery apparatus.

The present invention provides, in yet another aspect, a retainer adapted to support a fluid conduit for use with a pressurized fluid delivery apparatus. The delivery apparatus has at least two support members defining a first plane and an uppermost surface spaced from the first plane. The delivery apparatus defines a second plane including the uppermost surface that is substantially parallel with the first plane. The retainer includes a first portion engageable with the delivery apparatus, and a second portion spaced from the first portion. The second portion rigidly supports the fluid conduit with respect to the delivery apparatus such that a portion of the fluid conduit is always disposed above the second plane during normal operation of the delivery apparatus.

Other features and aspects of the present invention will become apparent to those skilled in the art upon review of the following detailed description, claims and drawings.

### BRIEF DESCRIPTION OF THE DRAWINGS

In the drawings, wherein like reference numerals indicate like parts:

FIG. 1a is a perspective view of a pressurized fluid delivery apparatus with an output assembly coupled thereto;

FIG. 1b is a side view of the pressurized fluid delivery apparatus and output assembly of FIG. 1a;

FIG. 2 is a perspective view of the pressurized fluid delivery apparatus and output assembly of FIG. 1a, illustrating an operator swiveling a hose about the pressurized fluid delivery apparatus;

FIG. 3 is an enlarged, partially-exploded perspective view of the output assembly of FIG. 1a;

FIG. 4 is an assembled perspective view of the output assembly of FIG. 3, illustrating the output assembly coupled to the pressurized fluid delivery apparatus and the fluid connection of the output assembly; and

FIG. 5 is an enlarged, partially-exploded perspective view of a second construction of the output assembly.

Before any features of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having”, and “comprising” and variations thereof herein is meant to encompass the items listed thereafter and equivalents thereof as well as additional items. The use of letters to identify elements of a method or process is simply for identification and is not meant to indicate that the elements should be performed in a particular order.

### DETAILED DESCRIPTION

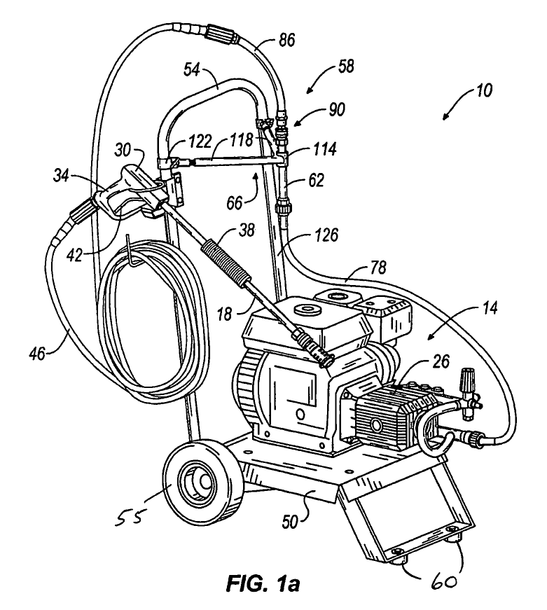

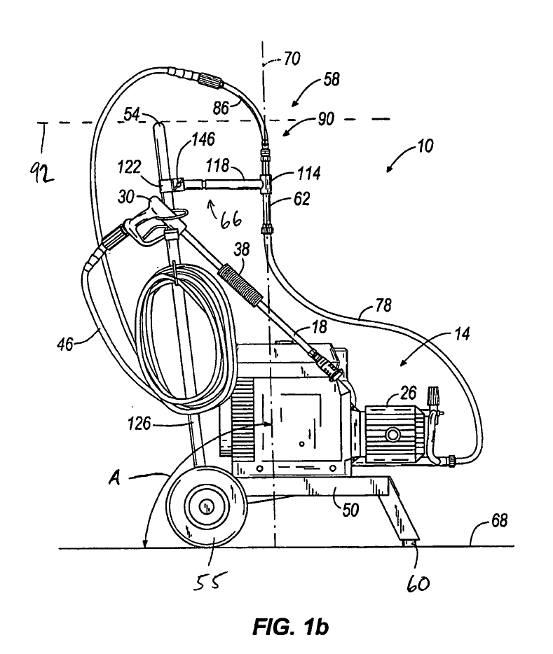

FIG. 1a illustrates a pressurized fluid delivery apparatus, such as a pressure washer 10, including a power unit 14 to provide a pressurized liquid to an output device, such as a wand 18. The power unit 14 may comprise an engine, electric motor, or other power unit. A pump 26 is operatively coupled to the power unit 14 to provide the pressurized liquid. As understood in the art, the pump 26 may receive a supply of low-pressure fluid, pressurize the fluid, and discharge the pressurized fluid to the wand 18. The wand 18 is coupled to a gun assembly 30 and acts as an extension to the gun assembly 30. Alternatively, the wand 18 may not be utilized and the gun assembly 30 may act as the output device.

The gun assembly 30 includes a hand grip 34 for a user to grasp with one hand, and the wand 18 includes a handle 38 to grasp with the other hand. A trigger 42 is located near the hand grip 34 to allow the user to selectively operate the gun assembly 30. The gun assembly 30 is fluidly connected with the pump 26 by an output conduit (e.g., flexible hose 46), which allows the power unit 14 and pump 26 to remain in one place while the user moves around and operates the gun assembly 30. Further, the power unit 14 and pump 26 may be transportable by a wheeled cart 50 or other transportation device. The cart 50 may include a frame having a U-shaped handle 54 for the operator to use when transporting the cart 50. The cart 50 includes a plurality of support members (e.g., wheels 55 or pads 56) defining a first plane 68 (see FIG. 1b).

FIG. 1a also illustrates an output assembly 58 fluidly connected between the pump 26 and the gun assembly 30. In the illustrated construction, the output assembly 58 is shown coupled to the U-shaped handle 54, however, the output assembly may also be coupled to other portions of the cart 50. The output assembly 58 includes a substantially rigid first or input conduit 62 defined along a central axis 70, and a retainer in the form of a V-shaped bracket 66 that supports the conduit 62 in an operating position relative to the first plane 68 when the conduit 62 receives pressurized fluid from the pump 26. With reference to FIG. 1b, the central axis 70 of the conduit 62 is angularly oriented from the support surface 68 by an angle A, which may be between about 45 degrees and about 135 degrees in defining the operating position of the conduit 62. In the illustrated construction, the angle A is substantially equal to 90 degrees. However, various applications of the output assembly 58 and the pressure washer 10 may employ values of A more or less than 90 degrees.

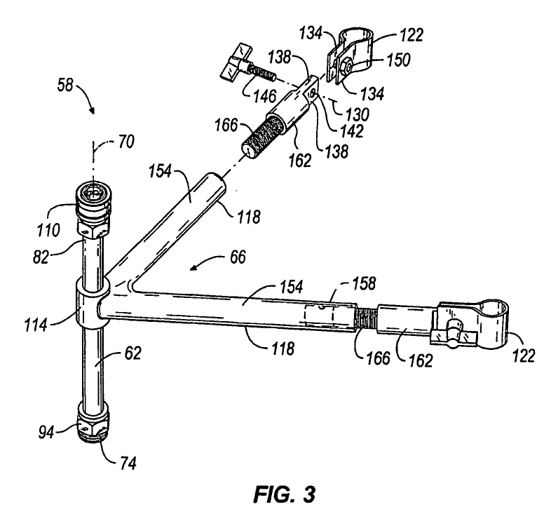

With reference to FIGS. 1a, 1b, and 3, the conduit 62 includes an inlet 74 fluidly connected to the outlet of the pump 26 via a connecting hose 78. The conduit 62 also includes an outlet 82 fluidly connected to a second or output conduit, the output conduit being in the form of the flexible hose 46, a curved conduit extension 86, or other pressure washer accessory, via a fluid coupling 90. The curved conduit extension 86 may be rigid to support an end of the hose 46 above the U-shaped handle 54 of the cart 50. A threaded fitting 94 may be coupled to the inlet 74 of the conduit 62 to threadably engage a mating threaded fitting 98 on the connecting hose 78 to secure the connecting hose 78 to the conduit 62. Alternatively, other couplings (quick-release or otherwise) may be used to secure and fluidly connect the connecting hose 78 and the conduit 62.

With reference to FIG. 1b, the bracket 66 rigidly supports at least a portion of the curved conduit extension 86 and at least a portion of the flexible hose 46 above a second plane 92 spaced from the first plane 68. However, in alternate constructions of the output assembly 58, the bracket 66 may be configured to rigidly support any fluid conduit with respect to the pressure washer 10 such that a portion of the fluid conduit is always disposed above the second plane 92 during normal operation. Such a fluid conduit may be a single, one-piece conduit fluidly interconnecting the pump 26 and the gun assembly 30, or alternatively, the fluid conduit may be formed of a plurality of fluidly connected sections (e.g., the hose 78, the conduit 62, the curved conduit extension 86, and the flexible hose 46 as shown in FIGS. 1a and 1b).

The second plane 92 includes an uppermost surface defined by the pressure washer 10 and is substantially parallel with the first plane 68. In the illustrated construction, the U-shaped handle 54 includes the uppermost surface defined by the pressure washer 10, and the second plane 92 includes, or is tangent to, the uppermost surface of the handle 54. However, in alternate constructions of the pressure washer 10, other components of the pressure washer (e.g., the engine, fuel tank, air cleaner assembly, blower housing, a liquid holding tank, etc.) may define the uppermost surface of the pressure washer 10.

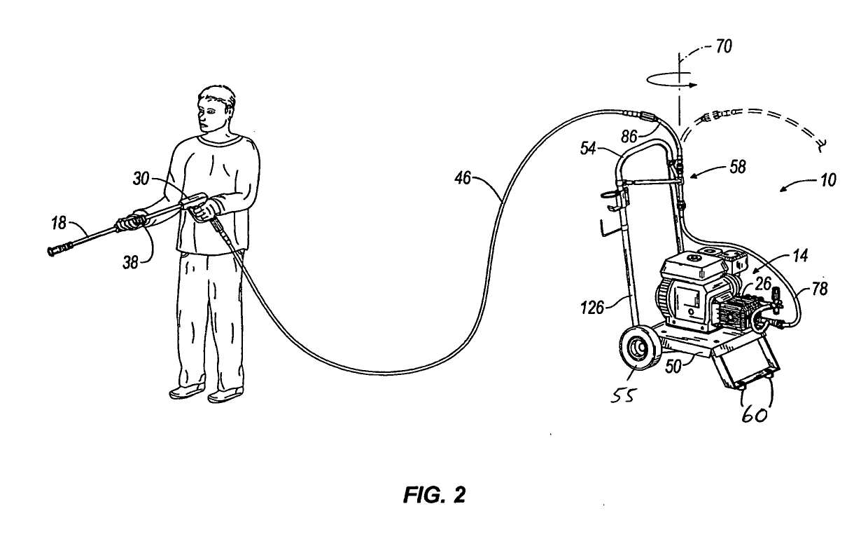

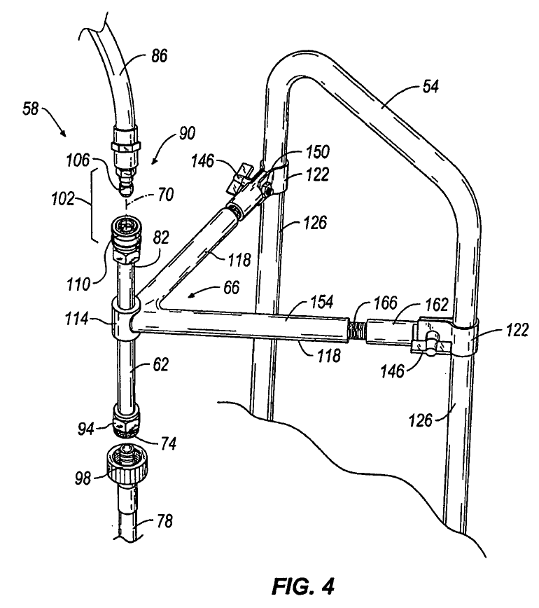

As shown in FIG. 4, the fluid coupling 90 is a quick-disconnect assembly 102 to allow for a quick release of the hose 46 and/or other pressure washer accessories from the conduit 62. The quick-disconnect assembly 102 also allows rotational, pivotal, or swiveling movement of the hose 46 about the central axis 70 (see FIG. 2). The quick-disconnect assembly 102 includes a male fitting 106 coupled to the curved conduit extension 86, and a female fitting 110 coupled to the outlet 82 of the conduit 62. The inter-engaging structure of the male and female fittings 106, 110 provide the rotational capability of the male fitting 106 relative to the female fitting 110. Although the illustrated construction of the output assembly 58 shows the male fitting 106 coupled to the curved conduit extension 86 and the female fitting 110 coupled to the outlet 82 of the conduit 62, alternate constructions of the output assembly 58 may couple the female fitting 110 to the curved conduit extension 86 and the male fitting 106 to the outlet 82 of the conduit 62.

In yet other alternate constructions of the output assembly 58, the fluid coupling 90 may be in a form different than the illustrated quick-disconnect assembly 102. In such a construction, the fluid coupling 90 may be any of a number of conventional fluid couplings 90 having a first component fixed to the conduit 62 and a second component permanently and rotatably connectable to the first component for rotation about the central axis 70. Further, the curved conduit extension 86 may be permanently fluidly connected to the conduit 62 via the fluid coupling 90.

As shown in FIG. 3, the bracket 66 includes a first portion, or a central support portion 114, and two arms 118 extending from the central support portion 114. In the illustrated construction, the arms 118 are integral with the central support portion 114 and extend from the central support portion 114 at a fixed angle between the arms 118 of about 60 degrees. However, alternate constructions of the bracket 66 may utilized an angular spacing between the two arms 118 more or less than 60 degrees depending upon the configuration of the pressure washer frame.

The central support portion 114 is configured to receive therein the conduit 62 and support the conduit 62 in a substantially transverse or perpendicular orientation with respect to the arms 118. In the illustrated construction of FIG. 3, the conduit 62 and central support portion 114 are made from metal, and the conduit 62 is fixedly coupled and secured to the central support portion 114 by a welding process. Alternatively, any of a number of different processes may be employed to fixedly couple the conduit 62 and the central support portion 114 (e.g., brazing, pressing, interference-fitting, etc.). In an alternate construction, the conduit 62 may be integral with the bracket 66 rather than a separate component. In yet another alternate construction, the conduit 62 and/or bracket 66 may be made from plastic, provided the plastic material can withstand the necessary pressures, forces, and/or moments acting on the conduit 62 and/or bracket 66.

The bracket 66 also includes a second portion engageable with the pressure washer 10 in the form of tubing clamps 122 mounted to each arm 118 of the bracket 66. The tubing clamps 122 couple the conduit 62 with a tubular member 126 of the cart 50. In the illustrated construction of FIG. 3, the tubing clamp 122 is configured to clamp onto a substantially round tubular member 126. However, alternate constructions of the tubing clamp 122 may be configured to clamp onto different shaped tubular members 126. For example, in the instance of the tubular members 126 comprising square tubing, the tubing clamps 122 may be configured to clamp onto the square tubing.

The tubing clamp 122 is pivotally coupled to the arm 118 via a pivot axis 130 that intersects the arm 118 to enable a substantially vertical orientation for the conduit 62. As shown in FIG. 3, the tubing clamp 122 includes opposing flanges 134 configured to engage opposing flat surfaces 138 formed at the tip of the arm 118. An aperture 142 defining the pivot axis 130 is formed through the arm 118 at a location on the arm 118 connecting the opposing flat surfaces 138. Corresponding apertures are formed in the opposing flanges 134 of the tubing clamp 122 such that a fastener 146 may be passed through the apertures to provide the pivotal movement of the tubing clamp 122 relative to the arm 118. In the illustrated construction, one of the flanges 134 on the tubing clamp 122 has a threaded member 150, such as a nut, coupled thereto and aligned with the corresponding aperture in the flange 134. The threaded member 150 may be configured to receive the fastener 146 to secure the tubing clamp 122 to the arm 118. In alternate constructions of the tubing clamp 122, the threaded member 150 may be coupled to the flange 134 (e.g., by welding, brazing, bonding, etc.), integral with the flange 134, or separate from the flange 134. In yet other alternate constructions of the tubing clamp 122, the threaded member 150 may not be utilized. Rather, a quick-release fastener or a pin may be used to provide rapid release and connection of the tubing clamp 122 with the arm 118.

With continued reference to FIG. 3, the bracket 66 is adjustable to adapt the conduit 62 for mounting to several different pressure washer assemblies 10 having several different frame and/or handle configurations. In the illustrated construction, the arms 118 are independently adjustable in length to position the respective tubing clamps 122 in a plurality of different relative positions. As such, the arms 118 may be configured to a plurality of different mounting positions to adapt to several different frame and/or handle configurations.

Each of the arms 118 is divided into a first member 154 having an internally-threaded portion 158 and a second member 162 having an externally-threaded portion 166 threadably engageable with the internally-threaded portion 158. To adjust the length of the arm 118, or the spacing between the first and second members 154, 162, the second member 162 may be “unscrewed” from the first member 154 to lengthen the arm 118, or the second member 162 may be “screwed into” the first member 154 to shorten the arm 118.

The bracket 66 is also adjustable to enable a substantially vertical orientation of the conduit 62. With reference to FIG. 3, the bracket 66, and subsequently the conduit 62, may be pivoted about the respective pivot axes 130 after mounting the bracket 66 to the frame and/or handle 54 of the pressure washer 10 to angularly position the conduit 62 relative to the support surface of the cart 50. Once the desired angular orientation of the conduit 62 is achieved, the fasteners 146 and threaded members 150 may be tightened to maintain a rigid connection between the tubing clamps 122 and the arms 118. For optimal operation of the output assembly 58, the mounted height of the conduit 62 and/or the curved conduit extension 86 should be sufficiently high to clear the handle 54 of the cart 50.

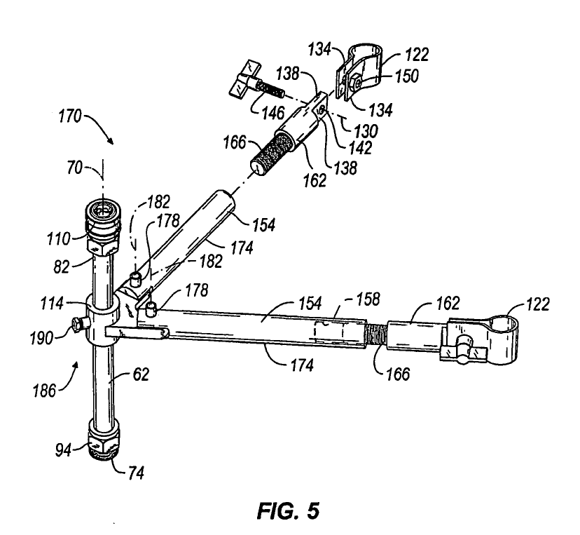

With reference to FIG. 5, an alternate construction of an output assembly 170 is shown with like parts having like reference numerals. In this construction, the arms 174 are pivotally coupled to the central support portion 114 via pinned connections 178 about respective pivot axes 182 parallel and offset from the central axis 70. This allows an additional degree of freedom in adjusting the output assembly 170 to adapt the conduit 62 for mounting to a variety of different pressure washer assemblies 10 having a variety of different frame and/or handle configurations.

The conduit 62 may also be movably adjustable along the central axis 70 relative to the central support portion 114 to vary the mounted height of the outlet 82 of the conduit 62. A locking mechanism 186 may be incorporated with the central support portion 114 to lock the conduit 62 in a plurality of different relative positions with the central support portion 114. In the illustrated construction, the locking mechanism 186 is in the form of a setscrew 190 positioned in the central support portion 114 to frictionally engage the outer surface of the conduit 62. Alternatively, other locking mechanisms 186 may be used to secure the conduit 62 in one of a plurality of different relative positions with the central support portion 114. As previously stated, for optimal operation of the output assembly 58, the mounted height of the conduit 62 and/or the curved conduit extension 86 should be sufficiently high to clear the handle 54 of the cart 50. The locking mechanism 186 provides additional capability to adjust the mounted height of the conduit 62 and/or the curved conduit extension 86.

The output assembly 58 may be incorporated into a kit, which may include the output assembly 58, as shown in FIG. 3, and the connecting hose 78. Such a kit may be retrofitted onto an existing pressure washer 10, provided the pressure washer 10 includes at least two spaced frame members to which the arms 118 may be attached. Alternatively, if the pressure washer does not include spaced frame members like the illustrated pressure washer 10, the kit may include additional bracket structure to adapt the bracket 66 to mount to other areas of the cart 50, such as, for example, the platform on which the power unit 14 is supported. Such additional bracket structure may also adapt the bracket 66 to be at least partially supported by the support surface 68.

With reference to FIG. 2, the output assembly 58 allows an operator to centrally locate the pressure washer 10 in an area to be washed and/or sprayed, and move about the pressure washer 10 without problematic entanglement of the hose 46. The structure of the fluid coupling 90, or the quick-disconnect assembly 102, allows the conduit 62 to remain stationary or fixed, while the hose 46 and curved conduit extension 86 are allowed to rotate or swivel 360 degrees about the central axis 70. As a result, the hose 46 is substantially prevented from entangling, curling, or kinking while being manipulated about the pressure washer 10 by the operator.

1. An output assembly adapted for use with a pressurized fluid delivery apparatus having an output device fluidly connected to an output conduit, the delivery apparatus having at least two support members defining a first plane and an uppermost surface spaced from the first plane, the delivery apparatus defining a second plane including the uppermost surface and substantially parallel with the first plane, the output assembly comprising:
an input conduit having an input in fluid communication with the delivery apparatus to receive a pressurized fluid therefrom, and having an output in fluid communication with the output conduit; and
a retainer coupling the input conduit with the delivery apparatus, the retainer rigidly supporting the input conduit on the delivery apparatus such that a portion of the output conduit is always disposed above the second plane during normal operation of the delivery apparatus.

2. The output assembly of claim 1, further comprising a fluid coupling coupled to the output of the input conduit, the fluid coupling comprising at least one of a first component fixed to the input conduit and a second component rotatably connectable to the first component for rotation about a central axis defined by the input conduit.

3. The output assembly of claim 2, wherein the first component comprises one of a male fitting and a female fitting of a quick-disconnect assembly, and the second component comprises the other of the male fitting and the female fitting.

4. The output assembly of claim 2, wherein the second component is pivotal with respect to the first component over a range of 360 degrees about the central axis.

5. The output assembly of claim 1, wherein the input conduit is fixedly coupled to the retainer against movement along a central axis of the input conduit and against movement around the central axis.

6. The output assembly of claim 1, wherein the retainer is adjustable to enable a substantially vertical orientation for the input conduit.

7. The output assembly of claim 6, wherein the retainer further comprises
a first member adapted to be fixed to the delivery apparatus; and
a second member pivotally coupled to the first member at one end and fixedly coupled to the input conduit at an opposite end, the second member being pivotal about a pivot axis substantially transverse to a central axis of the input conduit.

8. The output assembly of claim 1, wherein the retainer comprises a substantially rigid bracket to support the input conduit on the delivery apparatus.

9. The output assembly of claim 8, wherein the bracket comprises at least one arm positioning the input conduit at a distance from the delivery apparatus.

10. The output assembly of claim 1, the delivery apparatus including a tubular frame, wherein the retainer comprises a tubing clamp adapted to couple the input conduit with a tubular member of the tubular frame.

11. The output assembly of claim 1, wherein the retainer is adjustable to adapt the input conduit for mounting to a variety of different delivery apparatus.

12. The output assembly of claim 11, wherein the retainer further comprises
a first member comprising an externally-threaded portion; and
a second member comprising an internally-threaded portion, the externally-threaded portion being threadably engageable with the internally-threaded portion to vary a distance between the first member and the second member.

13. The output assembly of claim 1, wherein the retainer comprises a bracket to support the input conduit on the delivery apparatus, the bracket comprising at least one arm that retains the input conduit away from the delivery apparatus, the at least one arm pivotal about a pivot axis substantially parallel to and offset from a central axis of the input conduit.

14. The output assembly of claim 1, wherein a central axis of the input conduit is angularly oriented from the first plane between about 45 degrees and about 135 degrees.

15. The output assembly of claim 1, wherein the output conduit comprises a flexible hose, and wherein a portion of the flexible hose is always disposed above the second plane during normal operation of the delivery apparatus.

16. The output assembly of claim 1, wherein the second plane is tangent to the uppermost surface of the delivery apparatus.

17. A pressurized fluid delivery apparatus, comprising:
a frame having at least two support members defining a first plane and an uppermost surface spaced from the first plane, the frame defining a second plane including the uppermost surface and substantially parallel with the first plane;
a pump supported by the frame and adapted to provide a pressurized fluid;
an input conduit having an input that receives the pressurized fluid from the pump, and having an output;
an output conduit in fluid communication with the output of the input conduit; and
a retainer coupling the input conduit with the frame, the retainer rigidly supporting the input conduit on the frame such that a portion of the output conduit is always disposed above the second plane during normal operation of the delivery apparatus.

18. The pressurized fluid delivery apparatus of claim 17, further comprising a fluid coupling coupled to the input conduit, the fluid coupling comprising at least one of a first component fixed to the input conduit and a second component rotatably connectable to the first component for rotation about a central axis defined by the input conduit.

19. The pressurized fluid delivery apparatus of claim 18, wherein the first component comprises one of a male fitting and a female fitting of a quick-disconnect assembly, and the second component comprises the other of the male fitting and the female fitting.

20. The pressurized fluid delivery apparatus of claim 18, wherein the second component is pivotal with respect to the first component over a range of 360 degrees about the central axis.

21. The pressurized fluid delivery apparatus of claim 17, wherein the retainer comprises a substantially rigid bracket to support the input conduit on the frame.

22. The pressurized fluid delivery apparatus of claim 21, wherein the bracket comprises at least one arm positioning the input conduit such that the input conduit is spaced from the frame.

23. The pressurized fluid delivery apparatus of claim 17, wherein the retainer comprises a tubing clamp adapted to couple the input conduit with the frame.

24. The pressurized fluid delivery apparatus of claim 17, wherein the retainer is adjustable to adapt the input conduit for mounting to several different delivery apparatus.

25. The pressurized fluid delivery apparatus of claim 24, wherein the retainer further comprises
a first member comprising an externally-threaded portion; and
a second member comprising an internally-threaded portion, the externally-threaded portion being threadably engageable with the internally-threaded portion to vary a distance between the first member and the second member.

26. The pressurized fluid delivery apparatus of claim 17, wherein the retainer is fixedly coupled to the input conduit against movement along a central axis of the input conduit and against movement about the central axis.

27. The pressurized fluid delivery apparatus of claim 17, wherein the retainer is adjustable to enable a substantially vertical orientation for the input conduit.

28. The pressurized fluid delivery apparatus of claim 27, wherein the retainer further comprises
a first member adapted to be fixed to the delivery apparatus; and
a second member pivotally coupled to the first member at one end and fixedly coupled to the input conduit at an opposite end, the second member being pivotal about a pivot axis substantially transverse to a central axis of the input conduit.

29. The pressurized fluid delivery apparatus of claim 17, wherein the retainer comprises a bracket to support the input conduit on the delivery apparatus, the bracket comprising at least one arm that retains the input conduit away from the delivery apparatus, the at least one arm pivotal about a pivot axis substantially parallel to and offset from a central axis of the input conduit.

30. The pressurized fluid delivery apparatus of claim 17, wherein a central axis of the input conduit is angularly oriented from the first plane between about 45 degrees and about 135 degrees.

31. The pressurized fluid delivery apparatus of claim 17, wherein the output conduit comprises a flexible hose, and wherein a portion of the flexible hose is always disposed above the second plane during normal operation of the delivery apparatus.

32. The pressurized fluid delivery apparatus of claim 17, wherein the second plane is tangent to the uppermost surface of the frame.

33. A retainer adapted to support a fluid conduit for use with a pressurized fluid delivery apparatus, the delivery apparatus having at least two support members defining a first plane and an uppermost surface spaced from the first plane, the delivery apparatus defining a second plane including the uppermost surface and substantially parallel with the first plane, the retainer comprising:
a first portion rigidly supporting the fluid conduit with respect to the delivery apparatus such that a portion of the fluid conduit is always disposed above the second plane during normal operation of the delivery apparatus; and
a second portion spaced from the first portion that is engageable with the delivery apparatus.

34. The retainer of claim 33, wherein the first portion is adjustable with respect to the second portion to enable a substantially vertical orientation for at least a portion of the fluid conduit.

35. The retainer of claim 34, wherein the second portion is fixed to the delivery apparatus, and wherein the first portion is pivotally coupled to the second portion at one end and fixedly coupled to the fluid conduit at an opposite end.

36. The retainer of claim 33, the delivery apparatus including a tubular frame, wherein the second portion of the retainer comprises a tubing clamp adapted to couple the fluid conduit with a tubular member of the tubular frame.

37. The retainer of claim 33, wherein the retainer is adjustable to adapt the fluid conduit for mounting to a variety of different delivery apparatus.

38. The retainer of claim 37, wherein the retainer further comprises
a first member comprising an externally-threaded portion; and
a second member comprising an internally-threaded portion, the externally-threaded portion being threadably engageable with the internally-threaded portion to vary a distance between the first member and the second member.

39. The retainer of claim 38, wherein adjustment of the first member with respect to the second member varies a distance between the first portion of the retainer and the second portion of the retainer.
